(19) United States
(12) Patent Application Publication
(10) Pub. No.: US 2026/0231986 A1
(43) Pub. Date: Aug. 13, 2026

(54) DRINKING CURE BEVERAGE COMPRISING THREE COMPONENTS FOR BUILDING UP, PROMOTING AND MAINTAINING INTESTINAL HEALTH

(71) Applicant: EPIKUR INTERNATIONAL AG, Baar (CH)

(72) Inventors: Joost VOGELAAR, Neukirchen-Vluyn (CH); Franziska MOSTARD, Oberägeri (CH)

(21) Appl. No.: 19/149,541

(22) PCT Filed: Jan. 19, 2024
(86) PCT No.: PCT/EP2024/051238

§ 371 Date: Jul. 19, 2025

(30) Foreign Application Priority Data
Jan. 19, 2023 (CH) CH000050/2023

(51) Int. Cl. A23L 2/52; A23L 33/12; A23L 33/135; A23L 33/15; A23L 33/16; A23L 33/21

(52) U.S. Cl. CPC A23L 2/52; A23L 33/12; A23L 33/135; A23L 33/15; A23L 33/16; A23L 33/21; A23V 2002/00; A23V 2200/32

(57) ABSTRACT

Provided herein is a drinking cure that builds up, promotes, and maintains the intestinal microbiome (eubiosis), attained by a beverage having at least the following components: a probiotic herbal enzyme beverage (probiotic), a prebiotic combined with essential vitamins, minerals and trace elements, a natural nutritional oil which is rich in omega 3 fatty acids and contains tocopherol. These components are processed into an emulsion and the resultant beverage can be drunk regularly, preferably daily, as part of a drinking cure.

The invention relates to a special beverage consisting of three components, to be drunk in a drinking cure which should preferably be used daily. To understand the motivation for this special composition of this beverage and the biological and medical background for the selection of the components, and to explain this drinking cure and its effectiveness, some important definitions are given, some of which are referenced in square brackets to scientific literature:
Microbiome: In the narrower sense, this refers to the totality of microbial DNA in the human body. In a broader and colloquial sense, the term “microbiome” refers to the totality of all microorganisms in the human body. In humans, microbiomes are differentiated according to body niche (intestine, skin, oral cavity, vagina, etc.). The intestinal microbiome is located in the lumen in the outer mucus layer of the intestine.
Commensals: Describes the organism that lives together with another organism on the same food without harming it.
Eubiosis: Describes the balance of bacterial cultures in the microbiome of a healthy person.
Dysbiosis: Describes a disturbed balance of bacterial cultures in the microbiome, the opposite of eubiosis.
Vitality: Describes the body's own mental, physical, emotional and social performance.
Probiotics: Describes living, non-pathogenic microorganisms that provide health benefits to the host (here, specifically the intestine) [1].
Prebiotics: Describes substrates that are selectively used by host microorganisms (here, specifically the microbiome) and provide health benefits [2].

Synbiotics: Describes a mixture of probiotics and prebiotics with a health benefit for the host (here, specifically for the intestine) [3].

In the microbiome of the human gut, around 100 trillion (1014) bacteria are present. No other habitat on Earth is more densely populated. In the large intestine, there are 10¹⁰-10¹² bacteria per gram of biomass. The bacteria consist of >90% of the two anaerobic phyla Bacillota (>75%) and Bacteriodota (>15%) and form about 10,000 different commensal species. In the small intestine, the main species are Lactobacillus and Enterococcus, and in the large intestine the main species are Bifidobacterium alongside E. coli., Enterobacterium and Clostridium. This complex bacterial diversity makes humans a superorganism, possessing around 300 times more genes than a human cell and producing a metabolic potential around 100 times higher than the human liver [4].

The intestinal microbiome is considered an (endocrine) “superorgan” [5] or “second brain” [6]. It is a complex microbial ecosystem in which bacteria live together, communicate, exchange metabolic products and recombine. And this complex bacteria-gut interaction is strongly influenced by nutrition. Depending on the composition of the food and the bacterial composition, a variety of different physiologically active metabolites are formed in the microbiome.

The prerequisite for healthy vitality is balance (eubiosis) of the bacterial cultures in the microbiome. This requires the microbiome to be supplied with a balanced mix of the macronutrients carbohydrates, proteins and fats [7]. In the microbiome, indigestible nutrients such as complex glucans and glucoconjugates of plant cell walls (colloquially called dietary fiber or fiber), proteins along with glycine, taurine, bile acid and other conjugates, i.e., products resulting from the covalent coupling of at least two molecules, are metabolized. The anaerobic saccharolytic fermentation of the fiber results in “short-chain fatty acids” (SCFA) via pyruvic acid, i.e., acetic acid, propionic acid and butyric acid.

The change in the bacterial composition of the microbiome due to disturbances significantly affects vitality. Over 90% of all diseases and complaints are caused by dysbiosis. Prominent examples include chronic intestinal inflammation, obesity, diabetes, acne, atherosclerosis, asthma, neurodegenerative diseases and certain types of cancer [8]. Dysbiosis is caused by inadequate nutrient intake, poor nutrition, the intake of medication (especially antibiotics) and chronic stress.

Known metabolites of the intestinal microbiome include serotonin, short-chain fatty acids, various B vitamins (B1, B2, B5, B7, B9, B12), vitamin K, secondary bile acids and branched-chain amino acids. Functionally, these metabolites improve nutrient metabolism and regulate the cardiovascular, immune, and nervous systems via the gut-brain [9], gut-lung [10], gut-heart [11], and gut-skin [12] axes.

Carbohydrates, proteins and fats make up about 90% of the dry weight of food and 100% of its energy.

Various lactic acid bacteria strains of the genus Bifidobacterium also have a detoxifying effect. Lactic acid bacteria from the strain Enterococcus faecalis can also have a detoxifying and health-promoting effect. They cause oxalate breakdown and thus prevent the formation of kidney stones [13].

Bacteria of the genus Lactobacillus are heterofermentative lactic acid bacteria and ferment fiber via the phosphoketolase pathway to acetic acid and lactic acid. They are the most common bacterial genus in the microbiome [14].

It is known [15] that the bacteria of the genus Bifidobacterium present in the microbiome ferment the greatest variety of fiber. From the fermentation of the fiber, the hexoses are synthesized into acetic acid and lactic acid in a ratio of 3:2. Acetic acid is one of the “short-chain fatty acids” and is involved in the regulation of metabolism along with the immune and nervous systems.

Lactic acid is used for energy production (gluconeogenesis) and has numerous vascular effects. The short-chain fatty acids serve as an energy source for the epithelial cells of the intestine and are important signaling molecules. They bind to the receptors GPR41 and GPR43 on epithelial and immune cells. The receptors regulate the release of pro-inflammatory cytokines, which act directly on the central nervous system via GLP1 (glucagon-like peptide) and PYY (peptide-tyrosine-tyrosine). Furthermore, short-chain fatty acids inhibit histone deacetylase (HDAC) in immune cells and adipocytes and thus affect the transcription of these cells. In this way, the metabolism along with the immune and nervous systems are regulated.

The short-chain fatty acids are distributed throughout human tissue, including the brain, with the help of transporter proteins [16]. There, they regulate the metabolism along with the immune and nervous systems. In addition, the pH value is lowered to 5.5, thus preventing the proliferation of pathogenic intestinal bacteria.

Enzymes of intestinal bacteria metabolize the secondary bile acids from the bile acid conjugates. These emulsify the fats from food and thus allow for enzymatic fat breakdown by lipases.

Enzymes of the intestinal bacteria hydrolyze short-chain peptides and individual amino acids from the proteins. These are used to build up and regenerate the intestinal mucosa and are transported via the bloodstream to the cells, where they are used for protein biosynthesis.

The incidence of diseases based on impairment of the cardiovascular, immune and nervous systems has increased in Western civilization. The increase correlates with the declining consumption of fiber. There is a causal relationship between nutrition, the intake of fiber and the metabolic products formed from it through fermentation, such as short-chain fatty acids.

Nutrition and the resulting change in the composition of the microbiome is therefore directly linked to Western civilization diseases such as digestive problems, obesity, attention deficits, concentration and sleep disorders. Prevention or correction through specifically tailored probiotic food supplements is possible.

The intake of prebiotics influences the relative growth of bacterial strains and thus changes the bacterial composition of the microbiome and thus the composition of the physiologically active metabolic products.

Bearing in mind all these scientific findings, the object of the present invention is to provide a beverage for building up, promoting and maintaining intestinal health, which can be consumed daily as part of a drinking cure and is particularly effective and easy to use. The ingredients selected for the beverage are of crucial importance.

To achieve this object, a beverage is provided for building up, promoting and maintaining the intestinal microbiome (eubiosis), consisting of at least the following components:
a probiotic, with around 30 billion live lactic acid bacteria per 10 mL, and at least 10 natural herbs and spices that have been preserved by fermentation by mixing the herbs and bacteria with water and sugar cane molasses, as a result of which the bacteria consume the sugar in the molasses and convert it into lactic and acetic acid,
a prebiotic combined with essential vitamins, minerals and trace elements,
a natural nutritional oil which contains more than 50 wt. % of omega 3 fatty acids and tocopherol,
   by processing these components into an emulsion as a beverage and administering them preferably daily as part of a drinking cure.

Daily intake of this beverage as part of a drinking cure supports build up, promotion and maintenance of the intestinal health. The ingredients of the first component contain around 30 billion live lactic acid bacteria per 10 mL and over 10 different natural herbs and spices. Depending on the need, the probiotic can also contain bacteria from the strain Enterococcus faecium and one or more strains of the genera Lactobacillus and Bifidobacterium, for example these, which all originate from Denmark:
Lactobacillus acidophilus 43 |CIP 103598, ATCC 314, JCM 2121 |BacDiveID:135307—https://bacdive.dsmz.de/strain/135307
Enterococcus faecium |DSM 2146, ATCC 6057, WDCM 00177, NBRC 113009, CIP 106742, CCM 2308, CECT 8108 |BacDiveID:5295—https://bacdive.dsmz.de/strain/5295
Bifidobacterium bifidum Ti, Tissier |Type strain |DSM 20456, ATCC 29521, JCM 1255, BCRC 11845, BCRC 14615, CCUG 18364, CCUG 45217, CECT 870, CGMCC 1.2212, CIP 56.7, HAMBI 1380, IFO 14252, KCTC 3202, KCTC 3281, LMG 11041, LMG 8810, NBRC 100015, NBRC 14252, NCAIM B. 02021, NCFB 2715, NCIMB 702715, NCTC 13001, VTT E-97795, NCDO 2715 |BacDiveID:1693 https://bacdive.dsmz.de/strain/1693 These microorganisms are obtained through commercial channels or public culture collections and have been deposited by third parties in International Depositary Authorities (IDAs) in accordance with the Budapest Treaty. The deposits can be identified by the accession numbers noted above, and are publicly available from the bacterial diversity database known as BacDive under BacDive IDs noted above (135307, 5295, and 1693, respectively). The product is naturally preserved through fermentation, in which the herbs and bacteria are mixed with water and sugar cane molasses. The bacteria consume the sugar in the molasses and convert it into lactic and short-chain fatty acids.

The ingredients of the second component include >10 plant fibers as prebiotic substrates and >30 different minerals, vitamins and trace elements. The main component with >25 wt. % contains plant fiber consisting of complex glycans, such as glucomannans, arabinogalactans, xyloglucans, galacturonans, fructooligosaccharides or galactomannans. Galactomannans consist of β-1,4 linked mannose as the main chain, which is partially linked to α-1,6 galactose residues. For example, guar gum contains this glycan.

Clinical studies have shown that dietary supplements enriched with partially hydrolyzed guar gum achieve benefits and clinical effects in the reduction of diarrhea, in the treatment of irritable bowel syndrome and in constipation [17]. In addition, the availability of fat and cholesterol for resorption is significantly reduced and the risk of vascular diseases is reduced [18].

The prebiotic substrates contained in the second component are metabolized by the saccharolytically fermenting bacteria in the microbiome into lactic acid and the short-chain fatty acids acetic acid, propionic acid and butyric acid.

The purpose of the second component is to supply the microbiome with substrates that serve as precursors for the bacterial synthesis of short-chain fatty acids. Substrates that lead to toxic or harmful metabolites through bacterial synthesis are deliberately omitted in the second component.

The third component is a natural nutritional oil highly enriched in omega 3, such as linseed oil or Sacha Inchi nut oil. It contains >50% omega 3 fatty acids and up to 50 mg/ 100 mL of tocopherol. Omega 3 fatty acids promote the growth of butyric acid, one of the short-chain fatty acid producing bacteria in the microbiome. In this way, they prevent neurodegenerative diseases and protect against inflammation, arteriosclerosis and heart attacks [19].

Studies show that changes in microbiome composition are causally correlated with the occurrence of so-called lifestyle diseases. Lifestyle diseases are diseases that are related to the way of life. These include previously unknown incidences of metabolic diseases such as obesity and diabetes, inflammatory bowel diseases, asthma, allergies and immune deficiencies and neurodegenerative diseases [20].

In these diseases, a significant decrease in bacterial diversity and the loss of specific metabolic functions are observed. The absence of specific bacteria or dysbiosis is the cause of the occurrence of these complex diseases [21].

The daily, simultaneous, ritualized intake of the drinking cure based on the presented beverage with its three cardinal components has the purpose of ensuring that the supplied substances match the daily circadian fluctuations in the composition and function of the microbiome [22].

The simultaneous intake of the three components in a daily, ritualized drinking cure combines pro-and prebiotic food and nutritional supplements and thus results in a unique synbiotic preparation.

### BIBLIOGRAPHY

[1] C. Hill et al., “The International Scientific Association for Probiotics and Prebiotics consensus statement on the scope and appropriate use of the term probiotic,” Nat. Rev. Gastroenterol. Hepatol., vol. 11, no. 8, article no. 8, Aug. 2014, doi: 10.1038/nrgastro.2014.66.
[2] G. R. Gibson et al., “Expert consensus document: The International Scientific Association for Probiotics and Prebiotics (ISAPP) consensus statement on the definition and scope of prebiotics,” Nat. Rev. Gastroenterol. Hepatol., vol. 14, no. 8, article no. 8, Aug. 2017, doi: 10.1038/nrgastro.2017.75.
[3] K. S. Swanson et al., “The International Scientific Association for Probiotics and Prebiotics (ISAPP) consensus statement on the definition and scope of synbiotics,” Nat. Rev. Gastroenterol. Hepatol., vol. 17, no. 11, article no. 11, Nov. 2020, doi: 10.1038/s41575-020-0344-2.
[4] E. M. M. Quigley, “Gut Bacteria in Health and Disease,” Gastroenterol. Hepatol., vol. 9, no. 9, pp. 560-569, Sep. 2013.
[5] D. N. Schaenzler and P. D. med F. Beigel, Superorgan microbiome: The gut as the key to health and longer life. Gräfe Und Unzer, 2020.
[6] E. Mayer, The second brain: How the gut influences our mood, our decisions, and our well-being. Riva Verlag, 2016.
[7] J. Romano-Keeler, J. Zhang, und J. Sun, “The Life-Long Role of Nutrition on the Gut Microbiome and Gastrointestinal Disease,” Gastroenterol. Clin. North Am., vol. 50, no. 1, pp. 77-100, March 2021, doi: 10.1016/j. gtc.2020.10.008.
[8] A. Vijay und A. M. Valdes, “Role of the gut microbiome in chronic diseases: a narrative review,” Eur. J. Clin. Nutr., vol. 76, no. 4, article no. 4, Apr. 2022, doi: 10.1038/s 41430-021-00991-6.
[9] J. F. Cryan and S. K. Mazmanian, “Microbiota-brain axis: Context and causality,” Science, vol. 376, no. 6596, pp. 938-939, May 2022, doi: 10.1126/science. abo4442.
[10] R. Enaud et al., “The Gut-Lung Axis in Health and Respiratory Diseases: A Place for Inter-Organ and Inter-Kingdom Crosstalks,” Front. Cell. Infect. Microbiol., vol. 10, p. 9, Feb. 2020, doi: 10.3389/fcimb.2020.00009.
[11] H. Bartolomaeus, V. McParland, and N. Wilck, “Gut-heart axis,” Heart, vol. 45, no. 2, pp. 134-141, Apr. 2020, doi: 10.1007/s00059-020-04897-0.
[12] B. De Pessemier, L. Grine, M. Debaere, A. Maes, B. Paetzold, und C. Callewaert, “Gut-Skin Axis: Current Knowledge of the Interrelationship between Microbial Dysbiosis and Skin Conditions,” Microorganisms, vol. 9, no. 2, p. 353, Feb. 2021, doi: 10.3390/microorganisms 9020353.
[13] S. Hokama, Y. Honma, C. Toma, und Y. Ogawa, “Oxalate-Degrading Enterococcus faecalis ,” Microbiol. Immunol., vol. 44, no. 4, pp. 235-240, 2000, doi: 10.1111/j.1348-0421.2000.tb02489.x.
[14] E. Dempsey und S. C. Corr, “Lactobacillus spp. for Gastrointestinal Health: Current and Future Perspectives,” Front. Immunol., vol. 13, pp. 840245, 2022, doi: 10.3389/fimmu.2022.840245.
[15] A. A. Kolodziejczyk, D. Zheng, und E. Elinav, “Diet-microbiota interactions and personalized nutrition,” Nat. Rev. Microbiol., vol. 17, no. 12, article no. 12, Dec. 2019, doi: 10.1038/s41579-019-0256-8.
[16] S. Deleu, K. Machiels, J. Raes, K. Verbeke, und S. Vermeire, “Short chain fatty acids and its producing organisms: An overlooked therapy for IBD?,” eBioMedicine, vol. 66, Apr. 2021, doi: 10.1016/j.ebiom.2021.103293.
[17] J. L. Slavin und N. A. Greenberg, “Partially hydrolyzed guar gum: clinical nutrition uses,” Nutr. Burbank Los Angel. Cty. Calif, vol. 19, no. 6, p. 549-552, June 2003, doi: 10.1016/s0899-9007(02)01032-8.
[18] M. Minekus et al., “Effect of partially hydrolyzed guar gum (PHGG) on the bioaccessibility of fat and cholesterol,” Biosci. Biotechnol. Biochem., vol. 69, no. 5, pp. 932-938, May 2005, doi: 10.1271/bbb.69.932.
[19] A. Wu, Z. Ying, und F. Gomez-Pinilla, “Dietary Omega-3 Fatty Acids Normalize BDNF Levels, Reduce Oxidative Damage, and Counteract Learning Disability after Traumatic Brain Injury in Rats,” J. Neurotrauma, vol. 21, no. 10, pp. 1457-1467, Oct. 2004, doi: 10.1089/neu.2004.21.1457.
[20] L. E. Olofsson und F. Backhed, “The Metabolic Role and Therapeutic Potential of the Microbiome,” Endocr. Rev., vol. 43, no. 5, pp. 907-926, Sep. 2022, doi: 10.1210/endrev/bnac004.
[21] M. Jayachandran, J. Chen, S. S. M. Chung, und B. Xu, “A critical review on the impacts of β-glucans on gut microbiota and human health,” J. Nutr. Biochem., vol. 61, pp. 101-110, Nov. 2018, doi: 10.1016/j.jnutbio.2018.06.010.
[22] A. Mukherji, A. Kobiita, T. Ye, und P. Chambon, “Homeostasis in Intestinal Epithelium Is Orchestrated by the Circadian Clock and Microbiota Cues Transduced by TLRs,” Cell, vol. 153, no. 4, pp. 812-827, May 2013, doi: 10.1016/j.cell.2013.04.020.
[23] F. Perraudeau et al., “Improvements to postprandial glucose control in subjects with type 2 diabetes: a multicenter, double blind, randomized placebo-controlled trial of a novel probiotic formulation,” BMJ Open Diabetes Res. Care, vol. 8, no. 1, p.e001319, July 2020, doi: 10.1136/bmjdrc-2020-001319.

1. A beverage for building up, promoting and maintaining the intestinal microbiome (eubiosis), consisting of at least the following components:
a probiotic which contains approximately 30 billion live lactic acid bacteria per 10 mL, and at least 10 natural herbs and spices that have been preserved by fermentation by mixing the herbs and bacteria with water and sugar cane molasses, as a result of which the bacteria consume the sugar in the molasses and convert it into lactic and acetic acid;
a prebiotic combined with essential vitamins, minerals and trace elements;
a natural nutritional oil which contains more than 50 wt. % of omega 3 fatty acids and tocopherol, the components being processed into an emulsion as the beverage for administration periodically as part of a drinking cure.

2. The beverage according to claim 1, wherein the probiotic additionally contains living bacteria from the strain Enterococcus faecium and one or more strains of the genera Lactobacillus and Bifidobacterium.

3. The beverage according to claim 1, characterized in that the prebiotic comprises more than 10 plant fibers as prebiotic substrates and more than 30 different nutrients comprising minerals, vitamins and trace elements, a component of one or more ingredients of the prebiotic containing more than 25 wt. % of vegetable fiber from complex glycans comprising glucomannans, arabinogalactans, xyloglucans, galacturonans, fructooligosaccharides, and/or galactomannans, with a structure of β-1,4 linked mannose as a main chain with partially linked α-1,6 galactose residues.

4. The beverage according to claim 1, characterized in that the prebiotic, comprises more than 10 plant fibers as prebiotic substrates and more than 30 different nutrients comprising minerals, vitamins and trace elements, a component of one or more ingredients of the prebiotic containing more than 25 wt. % of fiber from a galactomannan class of glycans sourced from guar gum.

5. The beverage according to claim 1, characterized in that the natural nutritional oil is enriched in omega 3 fatty acids, a linseed oil or an oil of Sacha Inchi nut which contains more than 50% omega 3 fatty acids and up to 50 mg/100 mL of tocopherol.

6. The beverage according to claim 2, characterized in that the prebiotic comprises more than 10 plant fibers as prebiotic substrates and more than 30 different nutrients comprising minerals, vitamins and trace elements, a component of one or more ingredients of the prebiotic containing more than 25 wt. % of vegetable fiber from complex glycans comprising glucomannans, arabinogalactans, xyloglucans, galacturonans, fructooligosaccharides, and/or galactomannans with a structure of β-1,4 linked mannose as a main chain with partially linked α-1,6 galactose residues.

7. The beverage according to claim 2, characterized in that the prebiotic comprises more than 10 plant fibers as prebiotic substrates and more than 30 different nutrients comprising minerals, vitamins and trace elements, a component of one or more ingredients of the prebiotic containing more than 25 wt. % of fiber from a galactomannan class of glycans, sourced from guar gum.

8. The beverage according to claim 2, characterized in that the natural nutritional oil is enriched in omega 3 fatty acids, a linseed oil or an oil of Sacha Inchi nut which contains more than 50% omega 3 fatty acids and up to 50 mg/100 mL of tocopherol.

9. The beverage according to claim 3, characterized in that the natural nutritional oil is enriched in omega 3 fatty acids, a linseed oil or an oil of Sacha Inchi nut which contains more than 50% omega 3 fatty acids and up to 50 mg/100 mL of tocopherol.

10. The beverage according to claim 4, characterized in that the natural nutritional oil is enriched in omega 3 fatty acids, a linseed oil or an oil of Sacha Inchi nut which contains more than 50% omega 3 fatty acids and up to 50 mg/100 mL of tocopherol.
